(19) United States
(12) Patent Application Publication
(10) Pub. No.: US 2024/0297451 A1
(43) Pub. Date: Sep. 5, 2024

(54) PRESSURE MOUNT CONNECTOR AND ELECTRONIC SYSTEM

(71) Applicant: Amphenol Commercial Products (Chengdu) Co., Ltd, Chengdu (CN)

(72) Inventors: Rui He, Chengdu (CN); Xiaodong Hu, Chengdu (CN); Yaohua Hou, Chengdu (CN)

(73) Assignee: Amphenol Commercial Products (Chengdu) Co., Ltd., Chengdu (CN)

(21) Appl. No.: 18/592,638

(22) Filed: Mar. 1, 2024

(30) Foreign Application Priority Data
Mar. 2, 2023 (CN) 202310189999.8
Mar. 2, 2023 (CN) 202320361542.6

(51) Int. Cl. H01R 12/73; H01R 12/72; H01R 43/26

(52) U.S. Cl. CPC H01R 12/737; H01R 12/721; H01R 43/26

(57) ABSTRACT

A pressure mount connector that conforms to standard physical requirements while providing high performance at high speeds. The connector includes a housing holding conductive elements. The housing has a mating face, a slot extending through the mating face, and a mounting portion. Each conductive element has a mating portion curving into the slot, a contact tail opposite the mating portion, and an intermediate portion joining the mating portion and the contact tail. The contact tail extends in an angle to the intermediate portion, which can change when a normal force is exerted onto a contact surface of the contact tail. Connecting the mounting portion of the housing to a mounting component can provide the normal force. The contact tail is thinner and narrower than the intermediate portion and can have extensions, which reduces the risk of permanently deforming the contact tail by the normal force and improves signal integrity performance.

### CROSS-REFERENCE TO RELATED APPLICATIONS

This application claims priority to and the benefit of Chinese Patent Application Serial No. 202320361542.6, filed on Mar. 2, 2023. This application also claims priority to and the benefit of Chinese Patent Application Serial No. 202310189999.8, filed on Mar. 2, 2023. The entire contents of these applications are incorporated herein by reference in their entirety.

### TECHNICAL FIELD

This application relates generally to electrical interconnection systems, such as those including electrical connectors, used to interconnect electronic assemblies.

### BACKGROUND

may be. Card edge connectors are used widely in electrical systems. It is generally easier and more cost effective to manufacture components of an electrical system on several printed circuit boards (PCBs), and to connect the PCBs to other components of the electrical system using card edge connectors than to manufacture the electrical system as a single component. Sometimes, one PCB may be used as a main board or motherboard, while other PCBs in the system may be referred to as daughter boards or daughter cards that are connected to the motherboard by card edge connectors to interconnect these PCBs. In a computer, card edge connectors may be used on a motherboard to receive a memory card, a graphics card, or other PCBs that provide other functionalities.

One type of a card edge connector is a memory socket for receiving a memory card. The memory socket may be used, for example, to interconnect a memory daughter card with a motherboard. DDR5 (Double Data Rate Gen 5) is a memory specification widely used in computers today. A daughter card using DDR5 may be interconnected with the motherboard of a computer through a card edge connector. The card edge connector is fixed on the motherboard, and conductive elements on the card edge connector are interconnected with circuits on the motherboard. The daughter card is inserted into the slot of the card edge connector, so that the pads on the daughter card are electrically connected with corresponding conductive elements on the card edge connector, so as to provide electrical interconnection with circuitry on the motherboard through the card edge connector.

A known card edge connector includes a housing having a slot defined by two opposing side walls for receiving a daughter card. Each of the opposing side wall may include a row of openings exposing a plurality of conductive elements. A mating contact portion of a conductive element may extend into the slot through a corresponding opening in the side wall, such that when a daughter card is inserted into the slot, the conductive element may be electrically connected with a corresponding conductive pad on the daughter card via the contact portion. The card edge connector may also include an ejector for ejecting the daughter card and a lock for locking the daughter card in the slot.

Computers may be manufactured with multiple card edge connectors to receive multiple memory cards. Some computers may be manufactured with memory cards in all of those connectors. For cost reasons, other computers of the same design may be manufactured with memory cards in only some of the connectors. The user of those computers then has the option to later add memory cards where more performance from the computer is desired.

### SUMMARY

Aspects of the present disclosure relate to pressure mount connectors and electronic systems therewith.

Some embodiments relate to an electrical connector. The electrical connector may include a housing comprising a mating face, a mounting face opposite the mating face, and a slot extending through the mating face; and a plurality of conductive elements held by the housing, each of the plurality of conductive elements comprising a mating portion extending into the slot, a contact tail opposite the mating portion, and an intermediate portion joining the mating portion and the contact tail, the contact tail extending from and at an obtuse angle to a portion of the intermediate portion and comprising a widened portion configured to adjust an impedance of the contact tail.

Optionally, the contact tail comprises a body; and the widened portion is an extension extending from a side of the body.

Optionally, the extension is a first extension extending from a first side of the body of the contact tail; and the extension comprises a second extension extending from a second side of the body of the contact tail.

Optionally, the first extension and the second extension are disposed symmetrically about the body of the contact tail.

Optionally, the contact tail comprises a proximal end extending from the portion of the intermediate portion and a distal end opposite the proximal end; and the extension is disposed closer to the proximal end of the contact tail than to the distal end of the contact tail

Optionally, the body of the contact tail comprises a contact surface configured to make contact with a mounting component; and the contact surface of the body of the contact tail is disposed between the extension and the distal end.

Optionally, the slot extends in a longitudinal direction; and for each of the plurality of conductive elements, in the longitudinal direction, the intermediate portion is wider than the body of the contact tail, and not narrower than the body and the extension of the contact tail portion.

Optionally, the portion of the intermediate portion extends in a vertical direction perpendicular to the longitudinal direction; and the extension is spaced from the portion of the intermediate portion by a distance in a range of 0.3 mm to 0.5 mm in a transverse direction perpendicular to the longitudinal direction and the vertical direction.

Optionally, the mating portion comprises a contact surface; and the contact surface of the mating portion is spaced from the portion of the intermediate portion by a distance in a range of 0.4 mm to 0.5 mm in the transverse direction.

Optionally, the contact tail extends by a distance in a range of 2.4 mm to 2.8 mm in the transverse direction.

Optionally, the portion of the intermediate portion is thicker than the body of the contact tail.

Optionally, the portion of the intermediate portion has a thickness in a range of 0.23 mm to 0.30 mm; and the contact tail has a thickness in a range of 0.18 mm to 0.22 mm.

Optionally, the portion of the intermediate portion has a thickness of 0.25 mm; and the contact tail has a thickness of 0.20 mm.

Some embodiments relate to a method of operating an electrical connector, the electrical connector comprising a housing and a plurality of conductive elements held by the housing, the housing comprising a mating face, a slot extending through the mating face, and a mounting portion disposed on a side of the slot, and each of the plurality of conductive elements comprising a mating portion extending into the slot, a contact tail opposite the mating portion, and an intermediate portion joining the mating portion and the contact tail, wherein the contact tail comprises a first portion narrower than the intermediate portion and a second portion wider than the first portion. The method may include orienting the electrical connector such that the mounting face of the housing faces a surface of a printed circuit board, the printed circuit board comprising a plurality of contact pads on the surface; aligning the mounting portion of the housing of the electrical connector with a matching feature of the printed circuit board; and connecting the mounting portion of the housing of the electrical connector with the matching feature of the printed circuit board such that a connection between the first portion of each of the contact tails of the plurality of conductive elements and a respective contact pad of the plurality of contact pads on the surface of the printed circuit board generate a normal force of about 50 gf.

Optionally, the mounting portion of the housing comprises a buldge having a hole; the matching feature of the printed circuit board comprises an opening; and aligning the mounting portion of the housing of the electrical connector with the matching feature of the printed circuit board comprises aligning the hole of the buldge of the housing of the electrical connector with the opening of the printed circuit board.

Optionally, connecting the mounting portion of the housing of the electrical connector with the matching feature of the printed circuit board comprises inserting a connecting member through the hole of the buldge of the housing of the electrical connector into the opening of the printed circuit board.

Some embodiments relate to an electronic system. The electronic system may include a printed circuit board comprising a first row of contact pads and a second row of contact pads disposed in parallel to the first row of contact pads; and the electrical connector mounted on the printed circuit board. The electrical connector may include a housing comprising a mating face, a slot extending through the mating face, and a mounting portion disposed on a side of the slot and connected to a matching feature of the printed circuit board; and a plurality of conductive elements held by the housing, each of the plurality of conductive elements comprising a mating portion extending into the slot and a contact tail opposite the mating portion and thinner than the mating portion so as to pass data at DDR5 transmission rates, the plurality of conductive elements comprising a first plurality of conductive elements disposed on a first side of the slot and a second plurality of conductive elements disposed on a second side of the slot that is opposite the first side of the slot. The first and second plurality of conductive elements may be electrically connected to the first and second rows of contact pads, respectively, by a normal force exerted through the connection between the mounting portion of the housing of the electrical connector and the matching feature of the printed circuit board.

Optionally, the first and second rows of contact pads comprise first ends that are facing each other and second ends opposite respective first ends; and the first ends of the first and second rows of contact pads are separated from each other by a distance in a range of 2.4 mm to 3.2 mm.

Optionally, the second ends of the first and second rows of contact pads are spaced from each other by a distance in a range of 6.6 mm to 7.2 mm.

Optionally, for each of the plurality of conductive elements of the electrical connector, the contact tail comprises a first portion contacting a respective contact pad of the first and second rows of contact pads, and a second portion wider than the first portion.

Some embodiments relate to a pressure mount connector. The pressure mount connector may comprise an insulating housing provided with a slot extending in a longitudinal direction and recessed in a vertical direction; and a plurality of conductive elements held by the insulating housing. Each of the plurality of conductive elements may include a mating contact portion, a contact tail and an intermediate portion connected between the mating contact portion and the contact tail. The mating contact portion may be bent into the slot. The mating contact portion may include an mating contact surface inside the slot. The contact tail may be bent from the intermediate portion beyond the insulating housing, and the contact tail may include a mounting contact surface back to an opening of the slot.

Optionally, at least one of two sides of the contact tail opposite in the longitudinal direction may be provided with an extension.

Optionally, the extension may include a first extension and a second extension disposed on the two sides of the contact tail.

Optionally, the first extension and the second extension may be disposed symmetrically on the two sides of the contact tail.

Optionally, the contact tail may include a proximal end connected to the intermediate portion and a distal end opposite the proximal end, and a distance from the extension to the proximal end is less than a distance from the extension to the distal end.

Optionally, the mounting contact surface may be between the extension and the distal end.

Optionally, in the longitudinal direction, the contact tail may be connected to the middle of the intermediate portion. The intermediate portion may exceed the contact tail in the longitudinal direction toward two sides, and the extension may be not exceeding the intermediate portion in the longitudinal direction.

Optionally, the intermediate portion may extend in the vertical direction. In a transverse direction perpendicular to the longitudinal direction and the vertical direction, a distance from the extension to the intermediate portion may be between 0.3 mm and 0.5 mm.

Optionally, the intermediate portion may extend in the vertical direction. A distance from the mating contact surface to the intermediate portion may be less than or equal to 0.5 mm in the transverse direction.

Optionally, in the transverse direction perpendicular to the longitudinal direction and the vertical direction, a dimension of the contact tail may be between 2.4 mm and 2.8 mm.

Optionally, a thickness of the intermediate portion may be greater than a thickness of the contact tail.

Optionally, the thickness of the intermediate portion may be between 0.2 mm and 0.3 mm.

Optionally, the thickness of the contact tail may be between 0.18 mm and 0.22 mm.

Some embodiments relate to a pressure mount connector. The pressure mount connector may comprise an insulating housing provided with a slot extending in a longitudinal direction; and a plurality of conductive elements held by the insulating housing. Each of the plurality of conductive elements may include a mating contact portion, a contact tail and an intermediate portion connected between the mating contact portion and the contact tail. The mating contact portion may be bent into the slot. The contact tail may be bent from the intermediate portion beyond the insulating housing. In a transverse direction perpendicular to the longitudinal direction, the insulating housing may have a first side and a second side in opposite. At least one pair of mounting portions may be disposed on the first side and the second side. Each pair of the at least one pair of mounting portions may include a bulge and a recess on different sides. The bulge and the recess in each pair of the at least one pair of mounting portions may be mated with each other in shape, and the bulge and the recess in each pair of the at least one pair of mounting portions may be aligned in the transverse direction.

Optionally, multiple pairs of the mounting portions may be disposed on the first side and the second side. The multiple pairs of the mounting portions may be disposed with intervals in the longitudinal direction. The mounting portions of adjacent two pairs of mounting portions on the same side may include a bulge and a recess.

Optionally, three pairs of the mounting portions may be disposed on the first side and the second side.

Some embodiments relate to an electronic system. The electronic system may comprise a printed circuit board and a pressure mount connector. The pressure mount connector may comprise an insulating housing provided with a slot extending in a longitudinal direction; and a plurality of conductive elements held by the insulating housing. Each of the plurality of conductive elements may include a contact tail extending beyond the insulating housing. The printed circuit board may be provided with two columns of contact pads in the longitudinal direction. The plurality of conductive elements may be arranged in two columns in the longitudinal direction on two sides of the slot, and the two columns of contact pads may be electrically connected to the contact tails of the plurality of conductive elements in one-to-one correspondence.

Optionally, in a transverse direction perpendicular to the longitudinal direction, the two columns of contact pads may have first ends face to face. A transverse interval between the first ends may be between 2.4 mm and 3.2 mm.

Optionally, in a transverse direction perpendicular to the longitudinal direction, the two columns of contact pads may have second ends back-to-back. A transverse distance between the second ends may be between 6.6 mm and 7.2 mm.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a perspective view of an electronic system, according to some embodiments;

FIG. 2 is a cross-sectional perspective view of the electronic system of FIG. 1;

FIG. 3 is a cross-sectional view of the electronic system of FIG. 1;

FIG. 4 is a perspective view of a portion of a printed circuit board of the electronic system of FIG. 1;

FIG. 5 is a perspective view of a pressure mount connector of the electronic system of FIG. 1, according to some embodiments;

FIG. 6 is a top view of a plurality of pressure mount connectors of FIG. 5 arranged in a transverse direction;

FIG. 7 is a perspective view of a portion of the pressure mount connector of FIG. 5;

FIG. 8 is a cross-sectional view of a portion of the pressure mount connector of FIG. 5;

FIG. 9 is a perspective view of a portion of the pressure mount connector of FIG. 5;

FIG. 10 is an exploded perspective view of the pressure mount connector of FIG. 5;

FIG. 11 is a perspective view of a portion of an insulating housing of the pressure mount connector of FIG. 5, according to some embodiments;

FIG. 12 is a perspective view of a conductive element of the pressure mount connector of FIG. 5, according to some embodiments;

FIG. 13 is a perspective view of a portion of the conductive element of FIG. 12;

FIG. 14 is a side view of the conductive element of FIG. 12; and

FIG. 15 is a side view of a portion of the conductive element of FIG. 14.

The above accompanying drawings include the following reference signs:

100, 100′, pressure mount connector; 200, insulating housing; 201, mating face; 202, mounting face; 210, slot; 221, first side; 222, second side; 230, mounting portion; 231, 231′, bulge; 232, 232′, recess; 233, through-hole; 240, rib; 250, channel; 300, conductive element; 310, mating contact portion; 311, mating contact surface; 320, contact tail; 321, proximal end; 322, distal end; 323, mounting contact surface; 330, intermediate portion; 331, barb; 340, extension; 341, first extension; 342, second extension; 343, surface; 344, body; 400, reinforcing member; 900, printed circuit board; 910, contact pad; 911, first end; 912, second end.

### DETAILED DESCRIPTION

The inventors have recognized and appreciated designs for electrical connectors that support high performance, such as is required for a DDR5 connector, while being simple to install and mechanically robust. Such connectors, for example, may withstand multiple mating cycles.

Connectors as described herein may have a pressure mount interface for electrical connections to a substrate, such as a printed circuit board. A pressure mount interface, for example, may enable connectors to be easily installed in a computer or replaced in the field.

The inventors have recognized and appreciated, however, that the requirements of a mechanically robust and high performance pressure mount interface may be incompatible. Conventional contact tails to provide a pressure mount interface configured for the electrical properties to pass DDR5 signals with high integrity, for example, may degrade mechanically as the connector is used for many mating cycles. That degradation of the mechanical properties may in turn reduce signal integrity, interfering with operation of the connector.

Techniques as described herein may include using contact tails that are thin. The tails may be less than 0.25 mm thick, such as 0.2 mm. These tails may be thinner than intermediate portions of the contacts. Alternatively or additionally, the tails may be narrower than the intermediate portions.

Thinned contact tails may provide desirable mechanical properties, but may not provide an impedance or other electrical properties necessary for high performance. To carry DDR5 or other high performance signals, the contact tails alternatively or additionally may include widened portions. The widened portions may be extensions from an elongated body of the tails. The widened portions, for example, may be sized and positioned along the length of the body of the tail to provide a designed impedance of the connector or other desired signal integrity properties.

An electrical connector may include a housing holding conductive elements. The housing may have a mating face, a slot extending through the mating face, and a mounting portion. Each conductive element may have a mating portion curving into the slot, a contact tail opposite the mating portion, and an intermediate portion joining the mating portion and the contact tail. The contact tail may extend at an angle to the intermediate portion. The angle can change when a normal force is exerted onto a contact surface of the contact tail. Connecting the mounting portion of the housing to a mounting component can provide the normal force. The contact tail may be thinner and/or narrower than the intermediate portion and can have extensions. Such a configuration may reduce the risk of permanently deforming the contact tail by the normal force and improve signal integrity performance of the connector.

A pressure mount connector and electronic system therewith according to some embodiments of the present disclosure are described in detail hereinbelow in conjunction with the drawings. A vertical direction Z-Z, a longitudinal direction X-X and a transverse direction Y-Y may be shown in the drawings. The vertical direction Z-Z, the longitudinal direction X-X and the transverse direction Y-Y may be perpendicular to one another. The vertical direction Z-Z may refer to a height direction of the electrical connector, which in this example is a direction from the mounting interface of the connector towards a surface containing slots that receive a mating component. The longitudinal direction X-X may refer to a length direction of the electrical connector. The transverse direction Y-Y may refer to a width direction of the electrical connector, with the connector being elongated in the length direction and narrower in the width direction than the length direction.

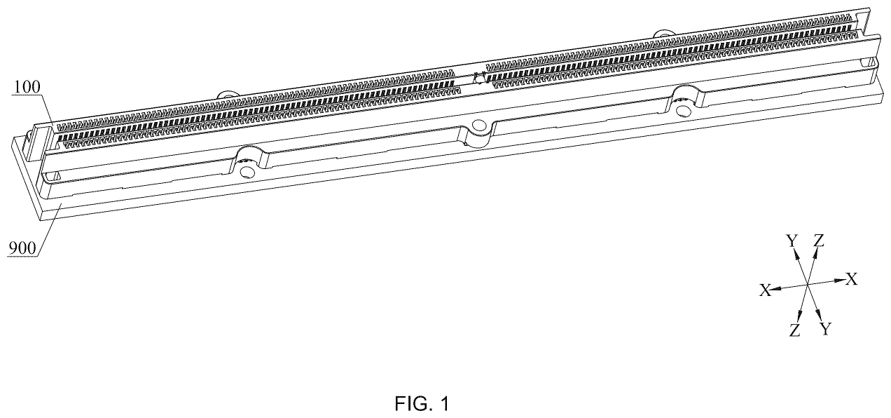

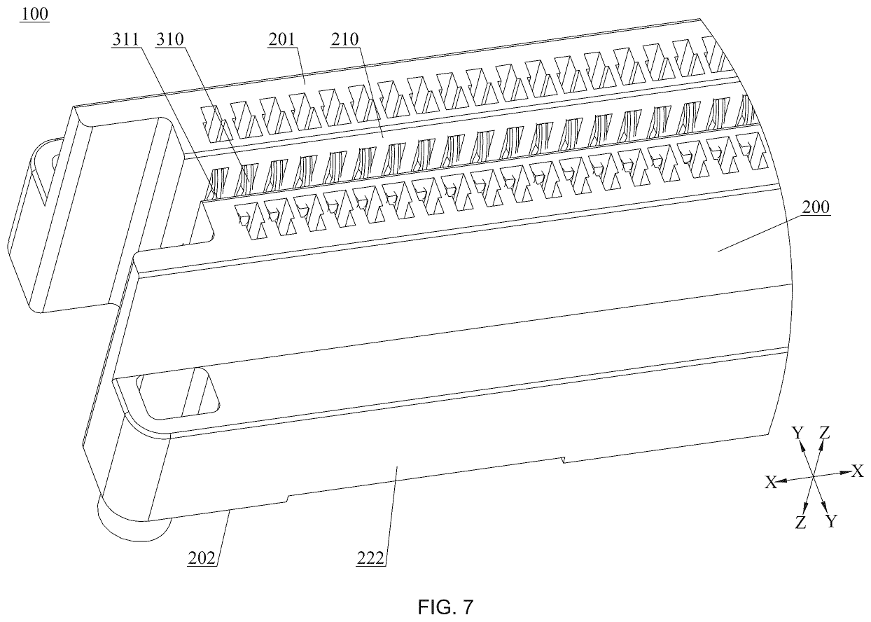

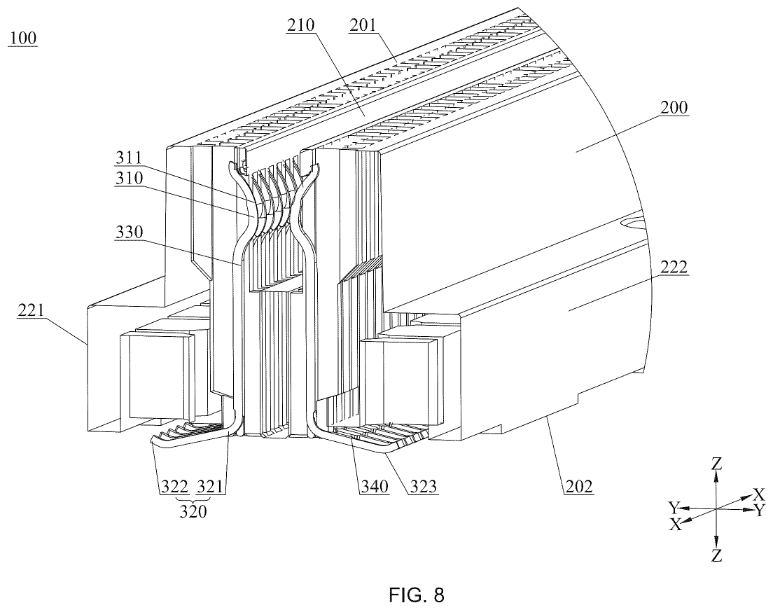

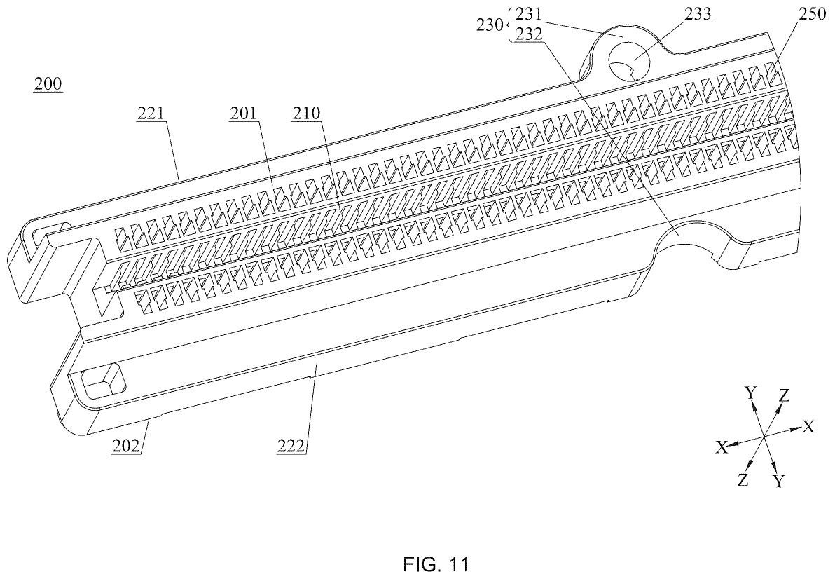

As shown in FIGS. 1-11, the electrical connector 100 may include an insulating housing 200. As shown in FIGS. 8 and 11, the insulating housing 200 may have a mating face 201 and a mounting face 202. The mating face 201 and the mounting face 202 may be arranged oppositely in the vertical direction Z-Z. A slot 210 may be formed in the mating face 201. Exemplarily, the slot 210 may be recessed inwards in the vertical direction Z-Z from the mating face 201. The slot 210 may be used for receiving at least part of an add-in card, such as an edge of the add-in card, so as to hold the add-in card to the insulating housing 200. The add-in card may be configured as a daughter card. The add-in card may include one or more of a display card, a memory card, a sound card and the like. The insulating housing 200 may be molded of an insulating material, for example, plastic. The insulating housing 200 may be an integral member.

Exemplarily, the insulating housing 200 may generally be in an elongated strip shape. The insulating housing 200 may extend in the longitudinal direction X-X. The slot 210 may be elongated in the longitudinal direction X-X. The add-in card may be inserted into the slot 210. The electrical connector 100 may be mounted onto a printed circuit board 900. The printed circuit board 900 may be configured as a mainboard.

The electrical connector 100 may further include a plurality of conductive elements 300. The plurality of conductive elements 300 may be held by the insulating housing 200. The plurality of conductive elements 300 may be arranged in the longitudinal direction X-X and spaced apart from each other in the insulating housing 200, enabling adjacent conductive elements 300 to be electrically insulated from each other. The plurality of conductive elements 300 may be arranged in two columns on opposite sides of the slot 210. Each column is parallel to the longitudinal direction X-X. Optionally, the two columns of conductive elements 300 may be aligned with each other in the longitudinal direction X-X. Optionally, the two columns of conductive elements 300 are staggered in the longitudinal direction X-X to increase the space between the conductive elements 300 in order to reduce crosstalk. For example, Joint Electron Device Engineering Council (JEDEC) specifies parameters that reflect SI performance for DDR5 including, for example, ended return loss, ended insertion loss, and the end crosstalk, such as Near End Crosstalk (NEXT) and Far End Crosstalk (FEXT), with a bandwidth of 20 GHz (see JEDEC 45.5). Optionally, two columns of conductive elements 300 have the same construction, but are mirror images of each other. The conductive elements 300 may be seated on one side of the slot 210.

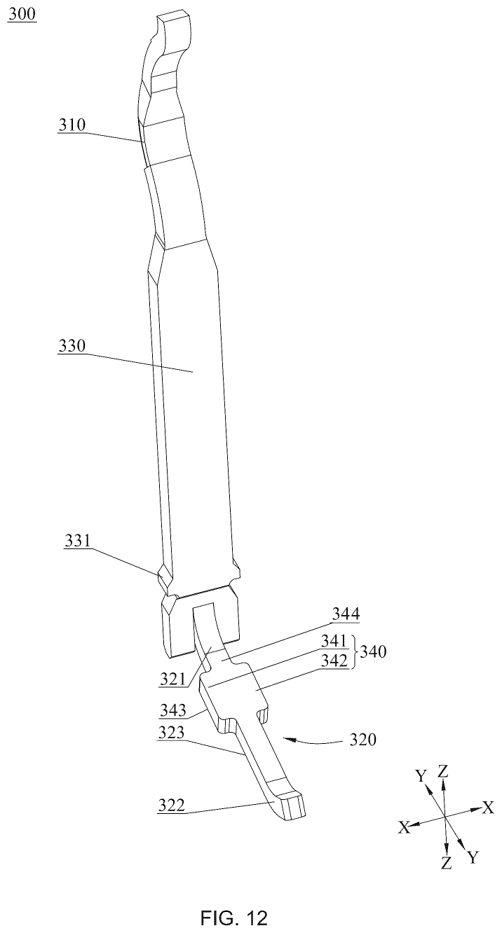

The conductive elements 300 may be made of a conductive material, such as metal. Each conductive element 300 may be an elongated one-piece member. Referring to FIGS. 12-15, each conductive element 300 may include a mating contact portion 310 and a contact tail 320 at two ends opposed each other in the extension direction of the conductive element 300, as well as an intermediate portion 330 connected between the mating contact portion 310 and the contact tail 320. The mating contact portion 310 may be accommodated in the insulating housing 200. The mating contact portion 310 may be on the side of the slot 210. Optionally, the mating contact portion 310 may be bent toward the slot 210 and protrude into the slot 210. The mating contact portion 310 may have a mating contact surface 311 in the slot 210. The add-in card may have a plurality of adapted conductive elements, such as golden fingers. When the add-in card is inserted into the slot 210, the mating contact surfaces 311 may electrically contact with the adapted conductive elements on the add-in card, such that the conductive elements 300 can be electrically connected to circuits of the add-in card. The contact tails 320 may be bent from the intermediate portions 330 beyond the insulating housing 200. As shown in the figures, the contact tails 320 may extend at an obtuse angle to the intermediate portion 330. The contact tails 320 may be used for press fitting to contact pads 910 on the print circuit board 900, thereby being electrically connected to contact pads 910. The obtuse angle may change (e.g., decrease) when the contact tails 320 are pressed against the contact pads 910 (the change may not be visible in the schematic figures). The contact tails 320 may have mounting contact surfaces 323 back to the opening of the slot 210. When the conductive elements 300 are press-mounted to the printed circuit board 900, the mounting contact surfaces 323 may electrically contact the contact pads 910, such that the conductive elements 300 are electrically connected to the circuits in the printed circuit board 900. In this way, the add-in card may be electrically interconnected to the printed circuit board 900 by the electrical connector 100.

The electrical connector 100 may be connected to the printed circuit board 900 by any suitable means to press the contact tails 320 of the conductive elements 300 onto the corresponding contact pads 910 on the printed circuit board 900. Exemplarily, the electrical connector 100 may be provided with any suitable mechanical connection structure, such as a snap or a connecting member, through which the electrical connector 100 may be secured to the printed circuit board 900. Optionally, the mechanical connection structure includes one or more of a snap and a threaded connecting member to facilitate a user's self-mounting of the electrical connector 100 on-site. When the electrical connector 100 is connected to the printed circuit board 900 in place, under the contact force (i.e., normal force) between the contact tails 320 and the contact pads 910, the contact tails 320 of the conductive elements 300 may be deformed to a certain extent. In this way, the contact tail 320 of each conductive element 300 can be pressure mounted to a corresponding contact pad 910 on the printed circuit board 900.

The electrical connector 100 provided in the embodiments of the present disclosure can be easily mounted to or dismounted from the printed circuit board 900 at the user's premise or in a factory. For example, if the electrical connector 100 is damaged due to repeated plugging in-out during a performance test of add-in cards, it is possible to easily and conveniently replace the electrical connector 100 with a new one. In addition, this eliminates the need of soldering, the manufacturing period is shortened, and the manufacturing costs are reduced.

The embodiments of the present disclosure further provide an electronic system. The electronic system may comprise the printed circuit board 900 and any of the electrical connectors 100 according to the embodiments of the present disclosure. In some embodiments, such as the embodiment shown in FIGS. 1-4 where the conductive elements 300 are arranged in two columns on opposite sides of the slot 210, the printed circuit board 900 may be provided with two columns of contact pads 910 arranged in the longitudinal direction X-X. The two columns of contact pads 910 may be in one-to-one correspondence with the contact tails 320 of the plurality of conductive elements 300.

The contact tails 320 may be configured to deform resiliently when they press fit to the contact pads 910 and restore their original states when the normal force required for compression mount is removed. This enables larger contact areas between the contact tails 320 and the contact pads 910 and smaller contact resistances at the interfaces between the two, such that SI performance is improved. One of the methods is to manufacture the conductive elements by using a material having a greater strength. However, the choices of materials may be limited by the electrical resistivities of the materials. The Inventors have recognized and appreciated that by increasing a longitudinal width of a portion of each contact tail 320, the contact tails 320 may bear greater normal force, allowing the contact tails 320 to fully contact with the contact pads 910. As a result, smaller contact resistance may be generated at the interfaces between the contact tails 320 and the contact pads 910. Such a configuration may enable the pressure mount connector to have an impedance of about 50 ohm and/or capable of making sufficient electrical contact with mating components by a contact normal force of about 50 gf (0.5N).

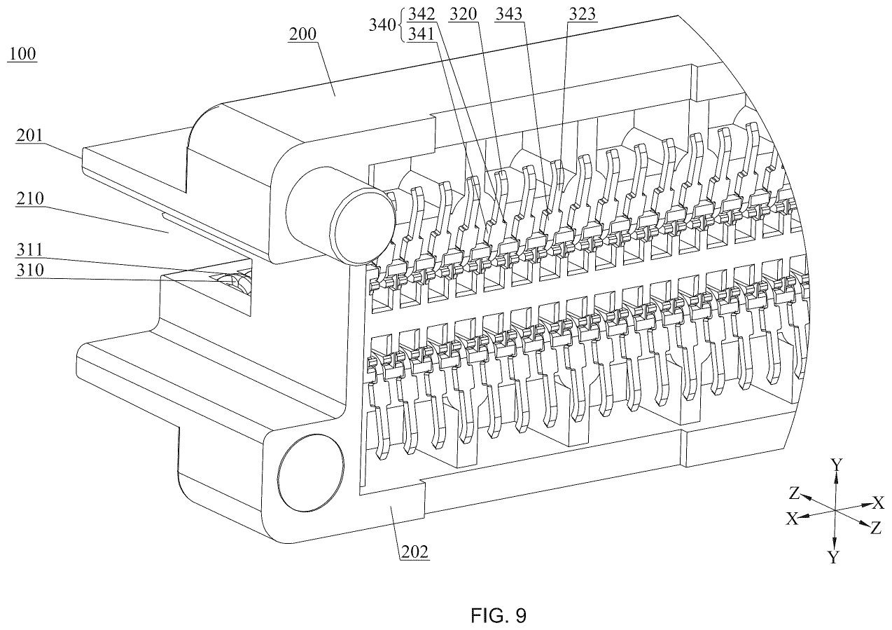

Exemplarily, as shown in FIGS. 9 and 12-15, at least one of the opposite two sides of the contact tail 320 in the longitudinal direction X-X may be provided with a body 344 and an extension 340 extending from one or more sides of the body 344. As a result, the contact tail 320 has an increased longitudinal width where the extension 340 is. The extension 340 may have any suitable shape, for example, as shown in the drawings, the extension 340 may be substantially in a rectangular shape. In addition, the extension 340 may be in any other regular shape, such as triangular shape, bowed shape, or trapezoidal shape; or, it may be in an irregular shape, such as sawtooth shape. There may be an extension 340 on one of the opposite sides of the body 344 of the contact tail 320 in the longitudinal direction X-X, or there may be extensions 340 on both sides of the body 344 of the contact tail 320. On each side, there may be one or more extensions 340. In the case where the extensions 340 are disposed on both sides and/or on one of the sides, the shapes of the extensions 340 may be the same or different. Even if the shapes are the same, the extensions 340 may have the same or different dimensions. The longitudinal width of the contact tail 320 may be increased by disposing the extensions 340, whereby the normal force applied to the contact tail 320 can be appropriately increased without permanently deforming the contact tail 320, and contact resistance at the interface can be reduced. In addition, by the extensions 340, body electrical resistance of the contact tail 320 can be adjusted, and resistance matching between the connector and the printed circuit board can be achieved. Signals transmitted by the electrical connector 100 with such extensions 340 have desired integrity. The dimensions of the extensions 340 may be adjusted to satisfy i) SI performance requirements and ii) the normal force required for compression mount within a limited PCB area.

Exemplarily, as shown in FIGS. 12-15, the extensions 340 may include a first extension 341 and a second extension 342. The first extension 341 and the second extension 342 may be disposed on the sides of the body 344 of the contact tail 320 opposed to each other in the longitudinal direction X-X. The first extension 341 and the second extension 342 may have the same or different shapes and dimensions. Optionally, it is inclined to evenly distribute the extensions 340 on opposite sides of the body 344 of the contact tail 320. Exemplarily, as shown in FIGS. 12-15, the first extension 341 and the second extension 342 are disposed symmetrically on the sides of the body 344 of the contact tail 320 opposed in the longitudinal direction X-X. The extensions 340 may also be disposed on opposite sides of the body 344 of the contact tail 320 in a non-symmetrical manner. In the illustrated embodiment, there is one first extension 341 and one second extension 342. Optionally, there may be multiple first extensions 341 and second extensions 342. Compared with providing the extension(s) 340 on only one side of the contact tail 320, the extensions 340 on two sides opposed in the longitudinal direction X-X may increase the longitudinal width of the contact tail 320, and the normal force can be uniformly borne on opposite sides of the contact tail 320, thereby enabling the electrical connector 100 to further satisfy the requirements for SI performance.

Exemplarily, as shown in FIGS. 12-15, the contact tail 320 may include a proximal end 321 and a distal end 322 disposed oppositely in its extension direction. The proximal end 321 may be connected to the intermediate portion 330. A distance from the extension 340 to the proximal end 321 may be less than a distance to the distal end 322. The extension 340 is in closer proximity to the proximal end 321. This configuration may allow the contact tail 320 to bear a greater normal force at a position closer to the intermediate portion 330. Such a configuration may reduce the risk of permanently deforming the contact tail 320 by the normal force. This configuration may enable the contact pads 910 of the printed circuit board 900 that are configured to make electrical contact with the contact tail 320 to be disposed closer to the center of the insulating housing 200 in the transverse direction Y-Y.

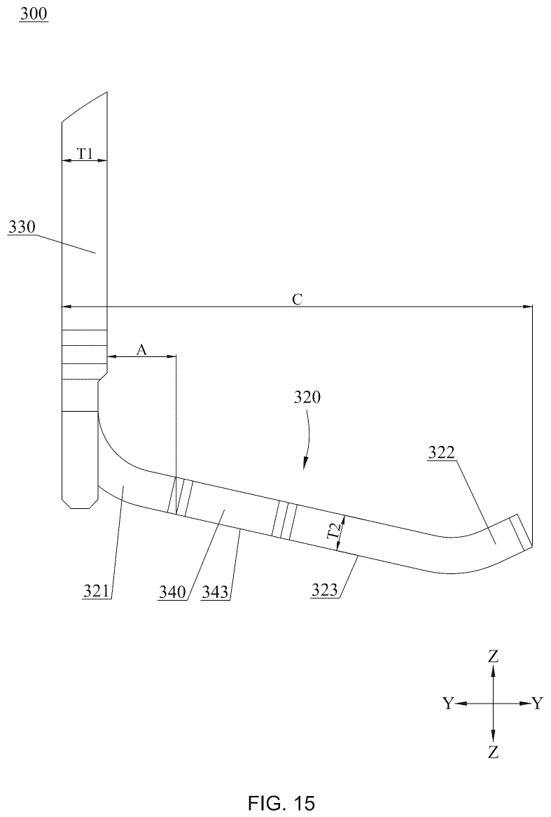

Exemplarily, as shown in FIG. 15, the intermediate portion 330 may extend in the vertical direction Z-Z. In the transverse direction Y-Y, a distance A from the extension 340 to the intermediate portion 330 may be approximately between 0.3 mm and 0.5 mm. Optionally, the distance A may be approximately between 0.35 mm and 0.4 mm. Exemplarily, as shown in FIG. 15, in the transverse direction Y-Y, a dimension C of the contact tail 320 may be approximately between 2.4 mm and 2.8 mm. Optionally, the dimension C may be approximately between 2.5 mm and 2.7 mm.

Exemplarily, the mounting contact surface 323 of the contact tail 320 may be disposed between the extension 340 and the distal end 322. The extension 340 may have a surface 343 facing the printed circuit board 900. The surface 343 may be higher than the mounting contact surface 323. When the conductive element 300 is pressure mounted to the printed circuit board 900, the mounting contact surface 323 may be electrically connected to the contact pad 910, while the extension 340 is not electrically connected to the contact pad 910. The portion of the contact tail 320 where the extension 340 is located may have relatively larger rigidity, enabling it to bear a larger normal force, while the portion of the contact tail 320 where the mounting contact surface 323 is located may be narrower in the longitudinal direction and relatively larger resilient, enabling the mounting contact surface 323 to tightly abut against the contact pad 910, so as to reliably ensure a desired and suitable contact area between the contact tail 320 and the contact pad 910, as well as an improved SI performance.

Exemplarily, as shown in FIGS. 12-15, in the longitudinal direction X-X, the contact tail 320 may be connected to the middle of the intermediate portion 330. The intermediate portion 330 may exceed the contact tail 320 in the longitudinal directions X-X toward both sides. The extension 340 does not exceed the intermediate portion 330 in the longitudinal directions X-X. With this configuration, the extensions 340 of adjacent conductive elements 300 would not come into electrical contact with each other, for example, even if the contact tails 320 are deformed, in particular the proximal ends 321 thereof, due to installation and/or transportation, etc.

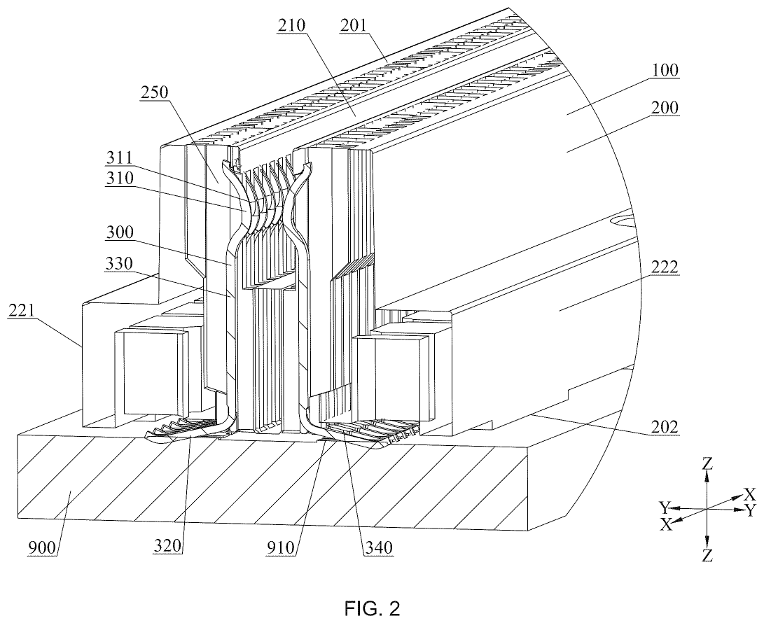

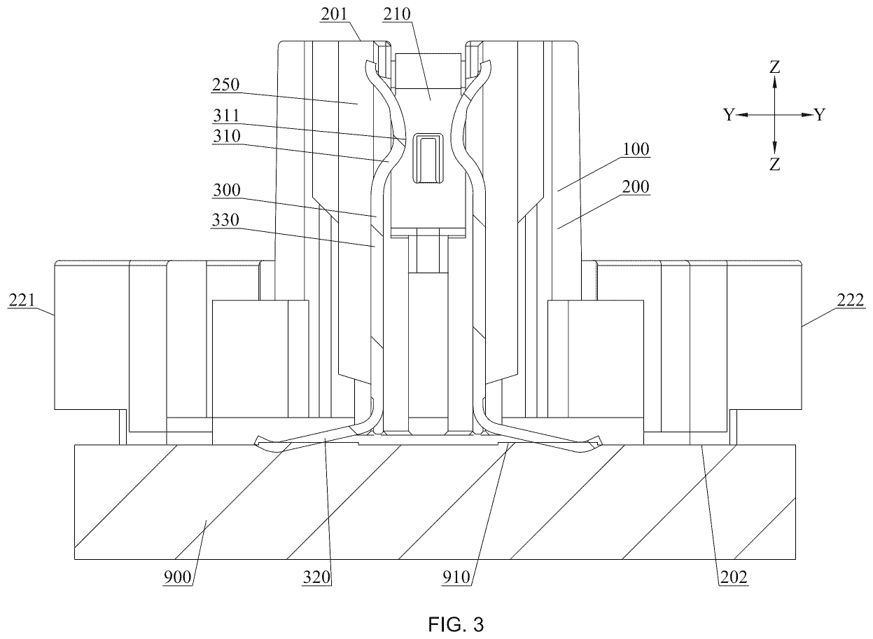

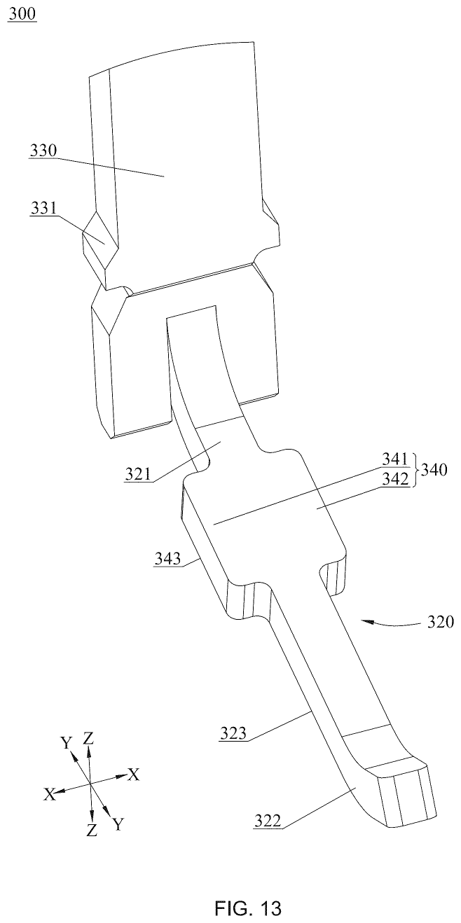

Exemplarily, as shown in FIG. 15, a thickness Tl of the intermediate portion 330 may be greater than a thickness T2 of the contact tail 320. The intermediate portion 330 may be sized such that it provides sufficient mechanical strength, for example, during assembly of the electrical connector 100. As shown in FIG. 11, the intermediate portion 330 may be smoothly inserted into a channel 250 in the insulating housing 200 as shown in FIG. 2, and may be in interference fit with the channel 250 via barbs 331 thereon (as shown in FIGS. 12-13). As shown in FIGS. 2-3, when the add-in card is inserted into the slot 210 of the electrical connector 100, the mating contact surfaces 311 on the mating contact portions 310 may make electrical contact with the adapted conductive elements of the add-in card, and the add-in card may push the mating contact portions 310 to move in the transverse direction Y-Y outwardly. The elasticity of the mating contact portions 310 can be enhanced by the intermediate portions 330, which may provide sufficiently large clamping force for the add-in card.

The thickness T1 of the intermediate portion 330 may be greater than the thickness T2 of the press fitting contact tail 320. The lower thickness T2 of the press fitting contact tail 320 can reduce the risk of permanently deforming the contact tail 320 by the normal force needed to establish sufficient electrical contact between the contact tail and a respective contact pad. Exemplarily, as shown in FIG. 15, the thickness T1 of the intermediate portion 330 may be approximately between 0.2 mm and 0.3 mm. Optionally, the thickness T1 may be approximately between 0.23 mm and 0.27 mm. Optionally, the thickness T1 may be 0.25 mm. Exemplarily, the thickness T2 of the contact tail 320 may be approximately between 0.18 mm and 0.22 mm. Optionally, the thickness T2 may be approximately between 0.19 mm and 0.21 mm. Optionally, the thickness T2 may be 0.2 mm. Such a configuration may enable the contact tail 320 to be sufficient resilient for being pressure mounted to the contact pad 910 on the printed circuit board 900.

Exemplarily, by changing, for example, an electroplated layer of the mating contact surface 311 and/or material of the mating contact portion 310, wear resistance of the mating contact surface 311 can be improved. In this way, the wear of the mating contact surface 311 caused by the adapted conductive element of the add-in card may be alleviated. The cycles for the electrical connector 100 to be plugged in and out can be increased.

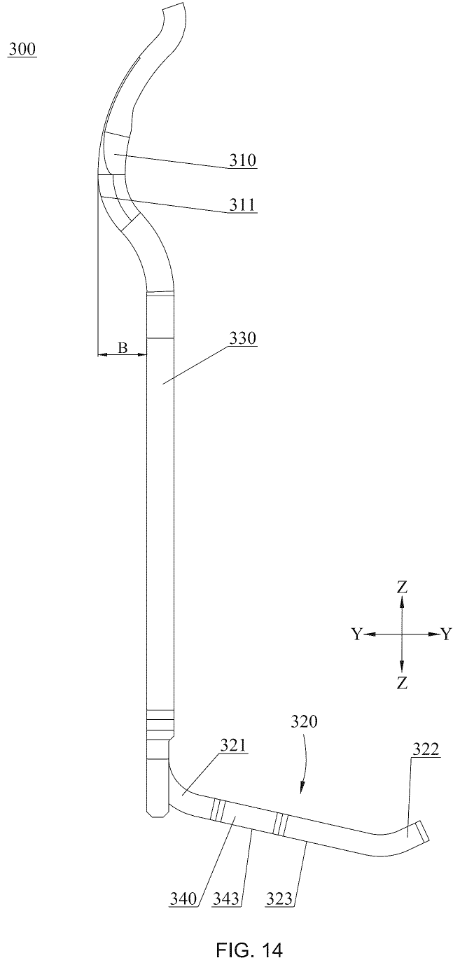

Exemplarily, as shown in FIG. 14, a distance B from the mating contact surface 311 to the intermediate portion 330 in the transverse direction Y-Y may be less than or equal to 0.5 mm. Optionally, the distance B may be approximately between 0.4 mm and 0.5 mm. Optionally, the distance B may be between 0.43 mm and 0.47 mm. Shortening the distance B may make the conductive element 300 closer to the center of the electrical connector 100 in the transverse direction Y-Y.

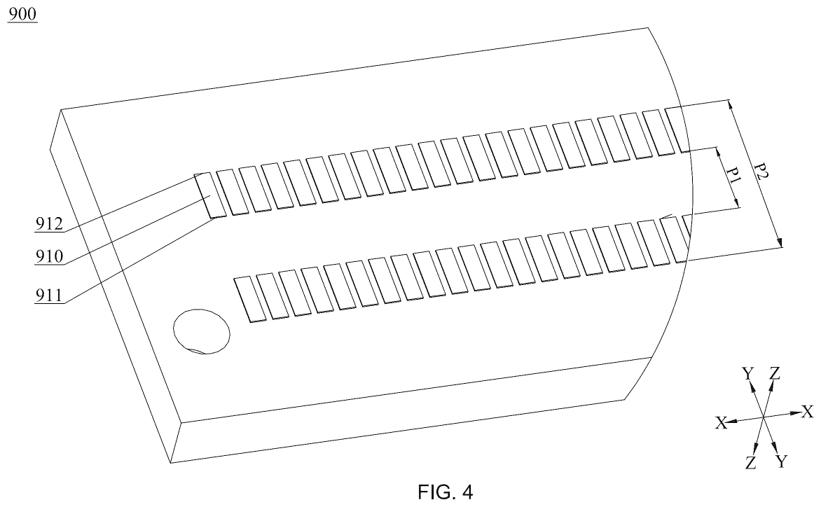

The two columns of conductive elements 300 of the electrical connector 100 may be connected to contact pads that are disposed in a high density on a printed circuit board (e.g., contact pads 910 on the printed circuit board 900). The extensions 340 may be disposed closer to the center of the electrical connector 100, e.g., closer to the center of force when the add-in card is plugged in and out, such that a larger proportion of the external force applied to the contact tails 320 of the conductive elements 300 can be shared by the extensions 340 when the add-in card is plugged in and out. Exemplarily, as shown in FIG. 4, in the transverse direction Y-Y, the two columns of contact pads 910 have first ends 911 face to face, and a transverse interval P1 between the first ends 911 may be approximately between 2.4 mm and 3.2 mm. Optionally, the interval P1 may be approximately between 2.6 mm and 3.0 mm. Optionally, the interval P1 may be between 2.8 mm and 3.0 mm. The smaller the interval P1 is, the higher the possibility of crosstalk between two columns of conductive elements 300 adjacent in the transverse direction Y-Y is. The larger the interval P1 is, the more space the two columns of contact pads 910 occupies, such that the utilization of the printed circuit board 900 becomes lower.

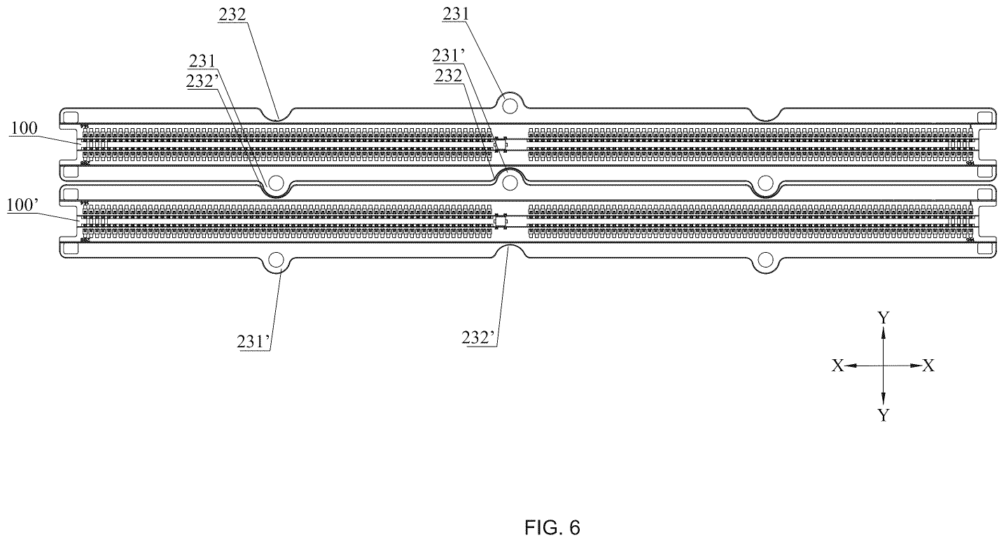

When a plurality of electrical connectors 100 are arranged closely together in the transverse direction Y-Y, as shown in FIG. 6, such a configuration enables a sufficiently large interval between the two columns of contact pads 910 for connecting adjacent two electrical connectors 100 and 100′ to reduce end crosstalk, when the distance B from the mating contact surface 311 to the intermediate portion 330 is less than or equal to 0.5 mm.

Exemplarily, as shown in FIG. 4, in the transverse direction Y-Y, the two columns of contact pads 910 have second ends 912 back-to-back, and a transverse distance P2 between the second ends 912 may be approximately between 6.6 mm and 7.2 mm. Optionally, the interval P2 may be approximately between 6.7 mm-7.0 mm. Optionally, the interval P2 may be between 6.7 mm-6.9 mm. When the distance B from the mating contact surface 311 to the intermediate portion 330 is less than or equal to 0.5 mm, the transverse dimension of each of the two columns of contact pads 910 may be made slightly larger so as to form a larger contact area and reduced contact resistance between the contact tail 320 and the corresponding contact pad 910, thereby improving SI performance. The transverse dimension of each contact pad 910 may be up to approximately 2 mm. Such a configuration may enable sizing the extension 340 in the transverse dimension such that the connector 100 can satisfy the requirement for contact resistance of DDR5 in JEDEC standards.

Exemplarily, as shown in FIGS. 2-3 and 5, the insulating housing 200 may have a first side 221 and a second side 222 opposite in the transverse direction Y-Y. At least one pair of mounting portions 230 may be disposed on the first side 221 and the second side 222. Each pair of the at least one pair of mounting portions 230 may include a bulge 231 and a recess 232. The bulge 231 and the recess 232 may be provided on different sides. For example, for one pair of mounting portions 230, when the bulge 231 is disposed on the first side 221, the recess 232 may be disposed on the second side 222; conversely, when the bulge 231 is disposed on the second side 222, the recess 232 may be disposed on the first side 221.

The bulge 231 and the recess 232 in each pair of the at least one pair of mounting portions 230 may be mated with each other in shape. The bulge 231 and the recess 232 in each pair of the at least one pair of mounting portions 230 may be aligned in the transverse direction Y-Y. With this configuration, when a plurality of electrical connectors 100 are mounted onto the printed circuit board 900 in the transverse direction Y-Y, as shown in FIG. 6, the bulges 231 and recesses 232 of adjacent electrical connectors 100 may be mated with each other. Optionally, the bulges 231 of one of the adjacent electrical connectors 100 can be inserted into the recesses 232 of the other of the adjacent electrical connectors 100. Once one electrical connector 100 is accurately secured to the printed circuit board, as shown in FIG. 6, the bulges 231 on one side of the electrical connector 100 may be complementary in shape to the recesses 232′ on the adjacent electrical connector 100′; or, the recesses 232 on the other side of the electrical connector 100 may be complementary in shape to the bulges 231′ on the adjacent electrical connector 100′. With this configuration, the electrical connector 100 may provide positioning effect for the electrical connector 100′. Moreover, the bulges 231 and the bulges 231′ do not occupy additional space on the printed circuit board. Such a configuration may enable the reduction of the space occupied by each electrical connector 100, and the reduction of the transverse center distance between adjacent connectors. And, the bulge 231 and the recess 232 included in each pair of mounting portions 230 can be aligned in the transverse direction Y-Y so that the insulating housings of the electrical connector 100 and the electrical connector 100′ have the same profile, i.e., it is sufficient to repeatedly arrange a plurality of the same pressure mount connectors without preparing two types of pressure mount connectors.

Exemplarily, as shown in FIG. 11, the bulge 231 may be provided with a through-hole 233 that penetrates through in the vertical direction Z-Z. The electrical connector 100 may also comprise a connecting member, such as screw (not shown). The connecting member may penetrate through the through-hole 233, and be fixed to the printed circuit board 900 to provide sufficient pressure for connecting the electrical connector 100 to the printed circuit board 900.

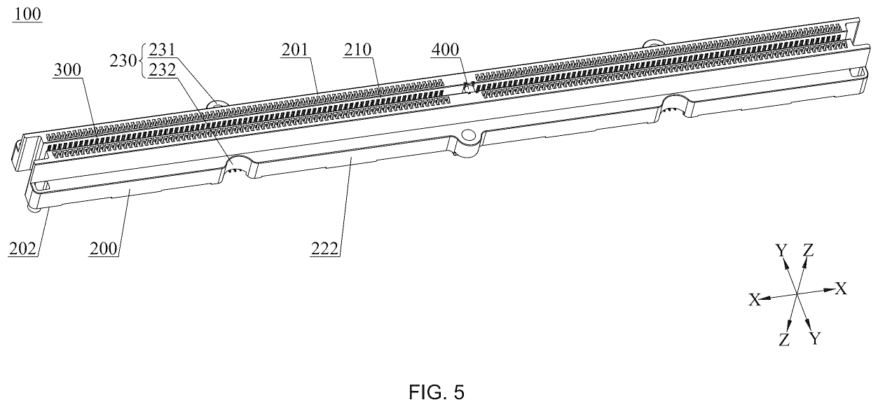

Exemplarily, as shown in FIG. 5, a plurality of pairs of mounting portions 230 may be provided on the first side 221 and the second side 222, and the plurality of pairs of mounting portions 230 may be disposed with intervals in the longitudinal direction X-X. The mounting portions 230 of adjacent two pairs of mounting portions 230 on the same side may include a bulge 231 and a recess 232. For example, on both the first side 221 and the second side 222, the bulges 231 and the recesses 232 are alternately distributed in the longitudinal direction X-X. Such a configuration may provide each side of the insulating housing 200 with a bulge 231 for fixation, so as to provide good positioning effect for the electrical connector 100.

Exemplarily, as shown in FIG. 5, three pairs of mounting portions 230 may be provided on the first side 221 and the second side 222. The three pairs of mounting portions 230 may be distributed in the longitudinal direction X-X. For each electrical connector 100, the electrical connector 100 can be firmly fixed to the printed circuit board by forming a triangular positioning though the three bulges 231 of the three pairs of mounting portions 230.

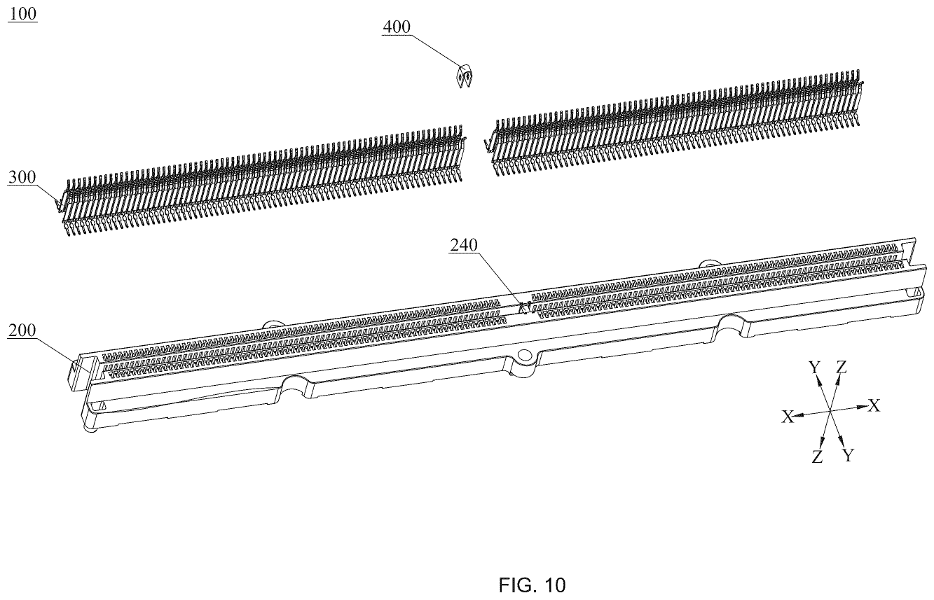

Exemplarily, as shown in FIG. 10, a rib 240 may be disposed within the slot 210. The rib 240 may divide the slot 210 into a plurality of independent segments in the longitudinal direction X-X. The rib 240 may increase the mechanical strength of the slot 210. Optionally, the rib 240 may provide a dummy-proof function by positioning at non-center positions of the slot 210.

Exemplarily, as shown in FIG. 10, the electrical connector 100 may further comprise a reinforcing member 400. The reinforcing member 400 may be configured to cover the rib 240 so as to provide protection to the rib 240. The reinforcing member 400 may be made of a material with greater strength, such as plastic, ceramic, metal, and the like. Optionally, the reinforcing member 400 may be made of metallic material. Metallic material has greater strength and lower material and processing costs. Optionally, the reinforcing member 400 is an integrated sheet metal piece. Such a configuration may enable the reinforcing member 400 to have greater strength, simple structure, and economic manufacturing process.

The Inventors have recognized and appreciated connector designs that may enable improved performance of computer systems that use high data rate buses to connect components to add-in cards, such as memory cards. These connector designs may enable connectors that are field installable. Connectors manufactured according to these designs may synergistically support high frequency connector operation, satisfy the physical requirements set by industry standards such as DDR5, and meet requirements for mass manufacturing, including cost, time and reliability.

Conventionally, unpopulated connectors are pre-installed on a computer motherboard in factories by, for example, soldering, so that additional cards may be added to the motherboard at a later time. The conductive elements of the unpopulated connector that are interconnected to signal paths on the motherboard can act as an unterminated stub. An unterminated stub can impact the signal integrity (SI) and electromagnetic interference (EMI) performance of the system. For example, a computer may be designed with a memory bus that transfers data between a processor and memories. Sockets may be attached to the bus at the time the computer is manufactured. Subsequently, if it is desired to add memory to the computer, memories on add-in cards may be inserted into the sockets. If some sockets are not populated with add-in memory cards, a performance problem may arise. A conductive element of an unpopulated socket designed to receive a DDR5 memory card, for example, has a terminal that extends a few mm (e.g., 6 mm) in length, which may cause stub resonance within the frequency range of high-speed signals on the memory bus to which that socket is connected. Such undesirable electromagnetic characteristics in the operating frequency range of the memory bus may create a particular high risk of interfering with operation of the memory bus.

Aspects of the present disclosure provide high performance, high speed electrical connectors that can be installed in the field by users, which may replace pre-installed unpopulated connectors. Such a connector may include conductive elements configured for pressure mount to a printed circuit board, which may require no additional materials and/or special tools that may be found in factories but not usually possessed by users.

According to aspects of the present disclosure, the contact tails may be provided with extensions on the sides. The extensions may adjust bulk resistance of the contact tails, so that SI performance may be improved. Further, the extensions may increase a longitudinal width of the contact tails so that they can withstand a greater normal force. Desired contact resistance between the contact tails and the contact pads can be achieved so as to improve SI performance. In some embodiments, the contact tails are configured to have a thickness less than that of the intermediate portions. This may be achieved by thinning the contact tails. Such a configuration may reduce the risk of permanently deforming the contact tails by the pressure needed to mount the connector, for example, even if the normal force is increased due to the increase of contact pad density.

According to aspects of the present disclosure, the intermediate portions of the plurality of conductive elements may be disposed closer to the center of the slot, such that the contact tails may extend toward both sides of the insulating housing in a transverse direction perpendicular to the longitudinal direction, starting from positions closer to the slot. Accordingly, the extensions may also be disposed closer to the center of the slot. The extensions may be disposed closer to the center of pressure on the plurality of conductive elements, such that the extensions can share the normal force exerted on the contact tails.

According to aspects of the present disclosure, for two pressure mount connectors disposed adjacent to each other in the transverse direction, distal ends (i.e., ends away from the intermediate portions) of adjacent two columns of contact tails on the different pressure mount connectors may be relatively away from one another. Two columns of contact pads on the printed circuit board that are in electrical contact with the adjacent two columns of contact tails may be away from one another, which in turn can reduce crosstalk and improve SI performance.

According to aspects of the present disclosure, a mechanical connection structure may be disposed on a side of the insulating housing of the pressure mount connector. The mechanical connection structure may be provided with a through-hole through which, a threaded fastener such as a screw, may be secured to the printed circuit board, such that the contact tails may exert stable normal pressure on the contact pads of the printed circuit board. In some embodiments, the mechanical connection structures of two adjacent pressure mount connectors may extend into the insulating housings of each other, thereby reducing the transverse center distance between the two pressure mount connectors. Such a configuration enables more pressure mount connectors to be mounted within a limited area on the printed circuit board. The extension of the contact tails disposed on opposite sides of the insulating housing from the positions closer to the slot may also enable disposing adjacent pressure mount connectors closer to each other.

The present disclosure has been described through the above embodiments, but it should be understood that a variety of variations, modifications and improvements may be made by a person skilled in the art according to the teaching of the present disclosure, and these variations, modifications and improvements all fall within the spirit of the present disclosure and the claimed scope of protection of the present disclosure. The scope of protection of the present disclosure is defined by the appended claims and its equivalent scope. The above embodiments are only for the purpose of illustration and description, and are not intended to limit the present disclosure to the scope of the described embodiments.

Various variations may be made to the structures illustrated and described herein. For example, the pressure mount connector described above can be of any suitable type, such as card edge connectors, backplane connectors, daughter card connectors, stacking connectors, Mezzanine connectors, I/O connectors, chip sockets, Gen Z connectors, etc.

As another example, although many inventive aspects have been described above with reference to the vertical connector, other configurations may also be used, such as right-angle connector. For example, the intermediate portion of a conductive element may have a bend such that the mating face and the mounting face of the housing extend at a right angle. A person of ordinary skilled in the art would understand that the mounting portion of the conductive element may extend from and in an obtuse angle to a portion of the intermediate portion. Any one of the inventive features, whether alone or combined with one or more other inventive features, can also be used for other types of connectors, such as right-angle connectors and coplanar connectors, and the like.

In the description of the present disclosure, it is to be understood that orientation or positional relationships indicated by orientation words “front”, “rear”, “upper”, “lower”, “left”, “right”, “transverse direction”, “vertical direction”, “perpendicular”, “horizontal”, “top”, “bottom” and the like usually are shown based on the accompanying drawings, only for the purposes of the case in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of ” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features”. Thus, the exemplary term “above” can encompass both the orientations of “above” and “below”. In addition, these components or features may be otherwise oriented (for example rotated by 90 degrees or other angles) and the present disclosure is intended to include all these cases.

It should be noted that the terms used herein are only for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

It should be noted that the terms “first”, “second” and the like in the description and claims, as well as the above accompanying drawings, of the present disclosure are used to distinguish similar objects, but not necessarily used to describe a specific order or precedence order. It should be understood that ordinal numbers used in this way can be interchanged as appropriate, so that the embodiments of the present disclosure described herein can be implemented in a sequence other than those illustrated or described herein.

What is claimed is:

1. An electrical connector comprising:
a housing comprising a mating face, a mounting face opposite the mating face, and a slot extending through the mating face; and
a plurality of conductive elements held by the housing, each of the plurality of conductive elements comprising a mating portion extending into the slot, a contact tail opposite the mating portion, and an intermediate portion joining the mating portion and the contact tail, the contact tail extending from and at an obtuse angle to a portion of the intermediate portion and comprising a widened portion configured to adjust an impedance of the contact tail.

2. The electrical connector of claim 1, wherein:
the contact tail comprises a body; and
the widened portion is an extension extending from a side of the body.

3. The electrical connector of claim 2, wherein:
the extension is a first extension extending from a first side of the body of the contact tail; and
the extension comprises a second extension extending from a second side of the body of the contact tail.

4. The electrical connector of claim 3, wherein:
the first extension and the second extension are disposed symmetrically about the body of the contact tail.

5. The electrical connector of claim 2, wherein:
the contact tail comprises a proximal end extending from the portion of the intermediate portion and a distal end opposite the proximal end; and
the extension is disposed closer to the proximal end of the contact tail than to the distal end of the contact tail.

6. The electrical connector of claim 5, wherein:
the body of the contact tail comprises a contact surface configured to make contact with a mounting component; and
the contact surface of the body of the contact tail is disposed between the extension and the distal end.

7. The electrical connector of claim 2, wherein:
the slot extends in a longitudinal direction; and
for each of the plurality of conductive elements, in the longitudinal direction, the intermediate portion is wider than the body of the contact tail, and not narrower than the body and the extension of the contact tail portion.

8. The electrical connector of claim 7, wherein:
the portion of the intermediate portion extends in a vertical direction perpendicular to the longitudinal direction; and
the extension is spaced from the portion of the intermediate portion by a distance in a range of 0.3 mm to 0.5 mm in a transverse direction perpendicular to the longitudinal direction and the vertical direction.

9. The electrical connector of claim 8, wherein:
the mating portion comprises a contact surface; and
the contact surface of the mating portion is spaced from the portion of the intermediate portion by a distance in a range of 0.4 mm to 0.5 mm in the transverse direction.

10. The electrical connector of claim 9, wherein:
the contact tail extends by a distance in a range of 2.4 mm to 2.8 mm in the transverse direction.

11. The electrical connector of claim 2, wherein:
the portion of the intermediate portion is thicker than the body of the contact tail.

12. The electrical connector of claim 11, wherein:
the portion of the intermediate portion has a thickness in a range of 0.23 mm to 0.30 mm; and
the contact tail has a thickness in a range of 0.18 mm to 0.22 mm.

13. The electrical connector of claim 12, wherein:
the portion of the intermediate portion has a thickness of 0.25 mm; and
the contact tail has a thickness of 0.20 mm.

14. A method of operating an electrical connector, the electrical connector comprising a housing and a plurality of conductive elements held by the housing, the housing comprising a mating face, a slot extending through the mating face, and a mounting portion disposed on a side of the slot, and each of the plurality of conductive elements comprising a mating portion extending into the slot, a contact tail opposite the mating portion, and an intermediate portion joining the mating portion and the contact tail, wherein the contact tail comprises a first portion narrower than the intermediate portion and a second portion wider than the first portion, the method comprising:
orienting the electrical connector such that the mounting face of the housing faces a surface of a printed circuit board, the printed circuit board comprising a plurality of contact pads on the surface;
aligning the mounting portion of the housing of the electrical connector with a matching feature of the printed circuit board; and
connecting the mounting portion of the housing of the electrical connector with the matching feature of the printed circuit board such that a connection between the first portion of each of the contact tails of the plurality of conductive elements and a respective contact pad of the plurality of contact pads on the surface of the printed circuit board generate a normal force of about 50 gf.

15. The method of claim 14, wherein:
the mounting portion of the housing comprises a buldge having a hole;
the matching feature of the printed circuit board comprises an opening; and
aligning the mounting portion of the housing of the electrical connector with the matching feature of the printed circuit board comprises aligning the hole of the buldge of the housing of the electrical connector with the opening of the printed circuit board.

16. The method of claim 15, wherein:
connecting the mounting portion of the housing of the electrical connector with the matching feature of the printed circuit board comprises inserting a connecting member through the hole of the buldge of the housing of the electrical connector into the opening of the printed circuit board.

17. An electronic system comprising:
a printed circuit board comprising a first row of contact pads and a second row of contact pads disposed in parallel to the first row of contact pads; and
the electrical connector mounted on the printed circuit board, the electrical connector comprising:
a housing comprising a mating face, a slot extending through the mating face, and a mounting portion disposed on a side of the slot and connected to a matching feature of the printed circuit board; and
a plurality of conductive elements held by the housing, each of the plurality of conductive elements comprising a mating portion extending into the slot and a contact tail opposite the mating portion and thinner than the mating portion so as to pass data at DDR5 transmission rates, the plurality of conductive elements comprising a first plurality of conductive elements disposed on a first side of the slot and a second plurality of conductive elements disposed on a second side of the slot that is opposite the first side of the slot, wherein:
the first and second plurality of conductive elements are electrically connected to the first and second rows of contact pads, respectively, by a normal force exerted through the connection between the mounting portion of the housing of the electrical connector and the matching feature of the printed circuit board.

18. The electronic system of claim 17, wherein:
the first and second rows of contact pads comprise first ends that are facing each other and second ends opposite respective first ends; and
the first ends of the first and second rows of contact pads are separated from each other by a distance in a range of 2.4 mm to 3.2 mm.

19. The electronic system of claim 17, wherein:
the second ends of the first and second rows of contact pads are spaced from each other by a distance in a range of 6.6 mm to 7.2 mm.

20. The electronic system of claim 17, wherein, for each of the plurality of conductive elements of the electrical connector, the contact tail comprises
a first portion contacting a respective contact pad of the first and second rows of contact pads, and
a second portion wider than the first portion.
